(19) United States
(12) Patent Application Publication
(10) Pub. No.: US 2004/0197611 A1
(43) Pub. Date: Oct. 7, 2004

(54) Transportable fuel cell generator

(76) Inventors: Alan Niedzwiecki, Laguna Beach, CA (US); Neel Sirosh, Irvine, CA (US); Andris R. Abele, San Clemente, CA (US)

Correspondence Address: GREENBERG TRAURIG LLP, 2450 COLORADO AVENUE, SUITE 400E, SANTA MONICA, CA, 90404, US

(21) Appl. No.: 10/408,055

(22) Filed: Apr. 4, 2003

(51) Int. Cl. H01M 8/00; H01M 8/04; H01M 8/18; H01M 8/10; H01M 8/12; H01M 2/00; H01M 2/02

(52) U.S. Cl. 429/13; 429/22; 429/34; 429/17; 429/23; 429/32; 429/19

(57) ABSTRACT

A portable fuel cell powered electrical generator. The portable fuel cell generator can be provided in a towable trailer, or it can be a portable enclosure which is movable on a trailer. A hydrogen fuel source is transported with the fuel cell generator. The electricity provided by the fuel cell generator can be supplied in as AC or DC current. Power conditioning occurs within the trailer or enclosure.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

This invention relates to a fuel cell device to provide portable electrical power. Among other applications, the device can be used for energy generation and distribution industries.

2. Description of the Related Art

Fuel cells generate electricity, quietly and cleanly. The Proton Exchange Membrane fuel cell (PEMFC) operates at low temperatures less than about 120 C. The PEMFC generates electricity by stripping an electron off hydrogen gas and allowing only a charged proton to pass through the membrane.

The art is rich in PEMFC patents for fuel cells used in transportation to power a vehicle. In some instance Fuel cell powered automobiles may use either compressed or liquefied hydrogen, hydrogen stored in a hydride, or hydrogen generated through reformation to provide a stream of hydrogen gas for use by the fuel cell.

Disruptions in the electrical power grid or supply interfere with the safety and order of society. To minimize electrical disruptions portable combustion back-up power generators are available. Combustion-type power generators in the over 50 KW range using gasoline or diesel fuel are noisy operating 60 to 100 decibels and the exhaust emitted posses serious health risks. Since 1990, diesel exhaust has been listed as a known carcinogen under California's Proposition 65. In 1998, the California Air Resources Board (CARB) listed diesel particulate as a toxic air contaminant. Also, see Findings of the Scientific Review Panel (SRP): “The Report on Diesel Exhaust as adopted at the Panel's Apr. 22, 1998”. It would be desirable to have a portable power supply which could provide at lest 50 KW of electrical power with reduce noise and pollution.

An infrastructure to supply hydrogen for fuel cell operation is not currently in existence. A portable fuel cell generator which can carry its own supply of hydrogen for power generation would be desirable.

### SUMMARY OF INVENTION

The transportable fuel cell electrical power generator carries its own fuel supply (about 35 KG (of hydrogen) for extended operation. By way of comparison an automobile would carry about 5 KG of hydrogen for a 200-300 mile range.

The hydrogen can be carried as a compressed gas stored in tanks at high pressure. The power generator can be placed in a transportable trailer or in a transportable enclosure.

In another embodiment the transportable fuel cell electrical power generator contains a hydrogen producing system, such a reformer using hydrogen rich fuels, and/or an electrolyzer or electrolytic cell. The hydrogen producing system can be used to refill the tanks of hydrogen.

A transportable generator self contained within an enclosure with its own fuel cell stack, balance of plant, hydrogen supply stored within the enclosure and with its own oxygen supply system. A system controller and a power conditioning system are also provided whereby DC and/or AC can be provided for output. In some instances, the transportable fuel cell generator may also be disassociated from the trailer for local use.

In some embodiments a hydrogen refilling system is also provided whereby gaseous hydrogen at a lower pressure can be fed into the transportable generator (through feed lines), and pressurized to a higher psi, and cooled, before storing the gaseous hydrogen in one or more hydrogen storage tanks.

Other features and advantages of the present invention will be set forth, in part, in the descriptions which follow and the accompanying drawings, wherein the preferred embodiments of the present invention are described and shown, and in part, will become apparent to those skilled in the art upon examination of the following detailed description taken in conjunction with the accompanying drawings or may be learned by practice of the present invention. The advantages of the present invention may be realized and attained by means of the instrumentalities and combinations particularly pointed out in the appendent claims.

### BRIEF DESCRIPTION OF THE DRAWINGS

FIG. 1 is an overview the transportable fuel electrical generator.

FIG. 2 is an overview the transportable fuel electrical generator.

FIG. 3 is a schematic of a PEMFC transportable generator.

FIG. 4 is partial cut-away top view of component arrangement inside a transportable fuel electrical generator.

FIG. 5 is partial cut-away top view of component arrangement inside a transportable fuel electrical generator.

### THE PREFERRED EMBODIMENTS OF THE INVENTION

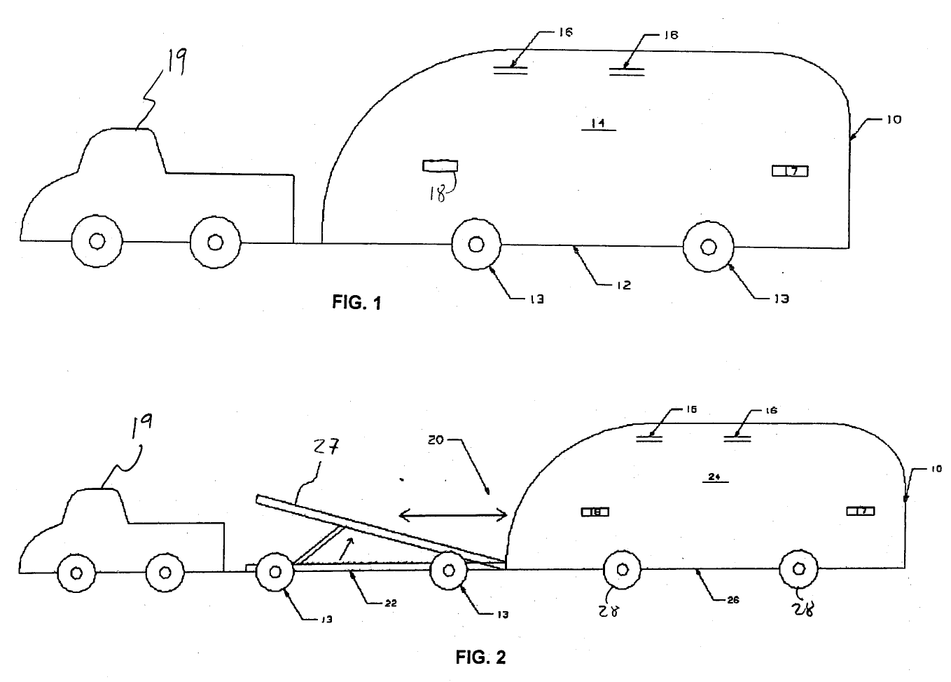

A transportable fuel cell generator within a trailer 10 is shown in FIG. 1. A substantially flat base 12, with wheels 13, which supports a lightweight shell 14 into which the fuel system, distribution system and electrical generation systems are placed. Vents 16 are provided in the lightweight shell 14. An electrical panel 17, accessible from the outside of the lightweight shell 14, at which electricity can be distributed from the transportable fuel cell generator within a trailer 10 is provided. A fueling panel 18 is also provided. The fueling panel 18 provides access to the fuel cell fuel system within the lightweight shell 14. A vehicle 19 can be used to tow the trailer 10.

A transportable fuel cell generator on a trailer 20 is shown in FIG. 2. In this embodiment a base 22, with wheels 13, which supports an enclosure module 24. The enclosure module 24 has its own module-base 25. Inside the lightweight module 24 are the fuel system, distribution system and electrical generation systems. The lightweight module 24 has vents 16. The enclosure module 24 can be used while on the base 22, or can be removed from the base 22 and set-up for local usage. An electrical panel 17, accessible from the outside of the lightweight module 24 at which electricity can be distributed is provided. A fueling panel 18 is also provided. The fueling panel 18 provides access to the fuel cell fuel system within enclosure module 24. Removal from the base can be facilitated by lifting the front edge 27 of the base 22 thereby lifting the base 22. Attached to the module-base 25 may be wheels 28 or a sled (extended flat surface) as shown in FIG. 6.

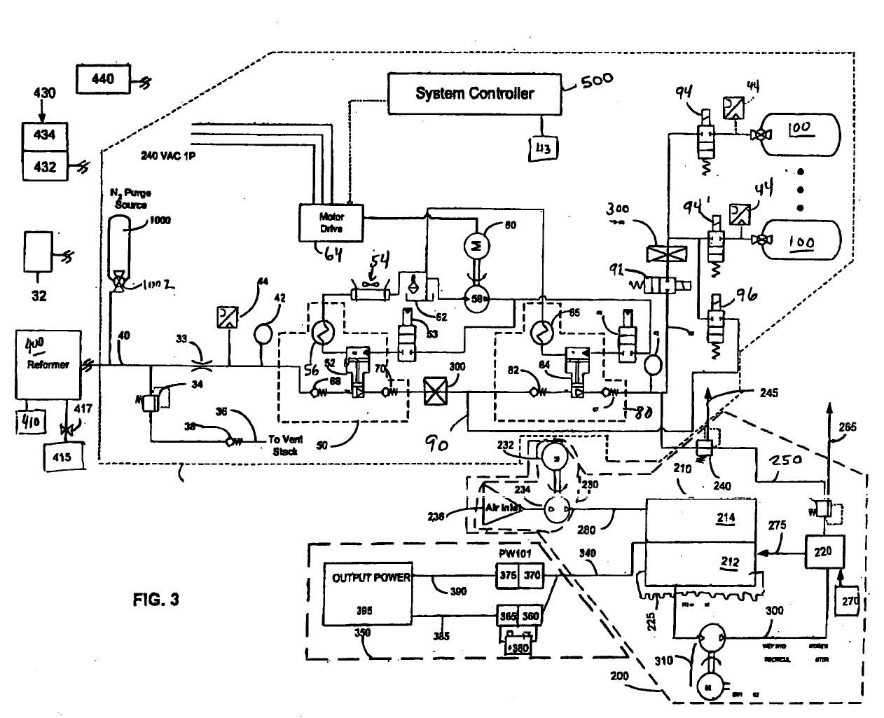

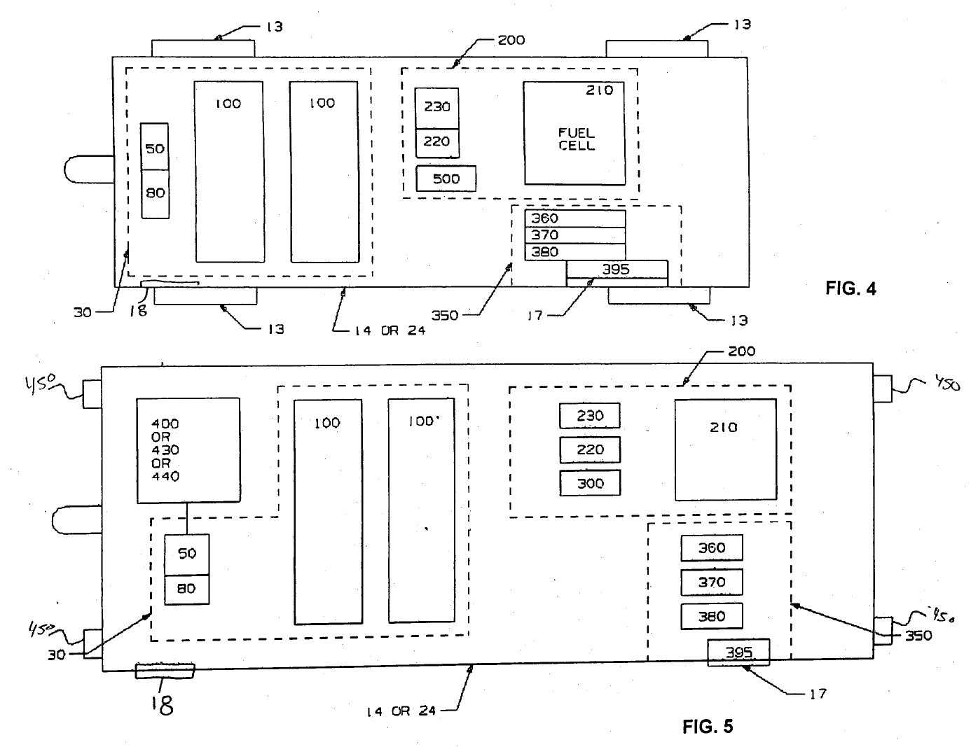

FIG. 3 is a schematic of a transportable fuel cell generator. In this embodiment the preferred fuel source is compressed hydrogen gas supplied from one or more internal hydrogen storage tanks 100 & 100.

Lightweight internal hydrogen storage tanks 100 should have a pressure rating of up to about 10,000 psi or more and a failure rating, or burst rating, of at least 2.25 times the pressure rating. One such hydrogen storage vessel is the Dynecell available from Dynetek Industries, Ltd. in Alberta, Canada. Another lightweight hydrogen storage vessel is the Tri-Shield available from Quantum Technologies, Inc. in Irvine, Calif.

Before the fuel cell generator can generate electricity the internal hydrogen storage tanks 100 in the refueling station 10 must be filled. A hydrogen storage subsystem 30 is provided to refill or charge the hydrogen storage tanks 100, a quick connect 32, which can be any standard hydrogen connector, is used to connect an external hydrogen source to hydrogen storage subsystem 30. The external hydrogen source can be a low pressure source preferably at least about 2400 psi. However, lower pressure sources of at least about 600 psi can be used.

Downstream from the quick connect 32 is a pressure release valve 34. The pressure release valve 34 is a safety element to prevent hydrogen, at a pressure exceeding a pre-determined maximum, from entering the hydrogen storage subsystem 30. If the pressure of hydrogen being introduced through the quick connect 32 exceeds a safe limit a restricted orifice 33 working in combination with a pressure relief valve 34 causes the excess hydrogen to be vented through a vent stack 36. In general, the valves are used to affect the flow of hydrogen within the refueling station. A check valve 38, between the vent stack 36 and pressure relief valve 34, maintains a one way flow of the flow of pressurized hydrogen being relived from the storage subsystem 30. The restrictive orifice 33 also prevents the hydrogen from entering the pressure rated feed line 40 at a rate which causes extreme rapid filling of the lightweight hydrogen storage tanks 100. Prior to connecting the quick connect 32 nitrogen gas, or other inert gas can be introduced into the feed line 40 to purge any air from the feed line. Pressurized nitrogen dispensed from a nitrogen tank 1000 can be introduced through a nitrogen filling valve 1002.

The feed line 40 should be constructed of stainless steel and typically has a safety margin of 4. Safety margins for a pressurized hydrogen gas line are a measure of burst pressure to operating pressure.

It is important to control the rate of fill of the hydrogen storage tanks 100 and in general the temperature of the gaseous hydrogen. Although a rapid fill is desired, physics dictates that as you increase the fill rate, all things being equal, an elevation in temperature will occur. With an elevation in temperature there is a corresponding decrease in the mass of hydrogen that can be stored at a predetermined input pressure. Accordingly, if the hydrogen entering the hydrogen storage tanks 100 is at an elevated temperature the density of the gaseous hydrogen will also be reduced. Cooling the gaseous hydrogen, by directing it through a cooling unit 2050, is used to reduce temperature elevations.

The cooling unit 300 in this embodiment is a finned tube type heat exchanger, however, other heat exchangers, coolers, or radiators which can manage the temperature of the gaseous hydrogen may be used. Temperature is measured at various places on the feed line 40 by temperature sensors 42 which are monitored by a system controller 500 which is typically based on a 8-32 bit microprocessor.

Connections between the feed line 40 sensors, valves, transducers, inlet or outlets, should be constructed to minimize any potential for leakage of hydrogen. Common construction techniques include welds, face seals, metal to metal seals and tapered threads. One or more hydrogen leak sensors 43 are also distributed and connected to the system controller 500. The pressure of the gaseous hydrogen is measured by one or more pressure sensors 44 placed in the feed line 40. No specific sensors is called out for but generally the sensor may be a transducer, or MEMS that incorporate polysilicon strain gauge sensing elements bonded to stainless steel diaphragms. The temperature and pressure of the hydrogen, entering the pressure rated feed line 40 can be checked as it passes into the first compressor subsystem 50.

The first compressor subsystem 50 contains an oil cooled first intensifier 52. An intensifier switch 53, connected to the system controller 400, controls the start/stop function of the first intensifier 52. An oil to air heat exchanger 54 for cooling hydraulic oil which is supplied to a first intensifier heat exchanger 56 to cool the first intensifier 52. A hydraulic pump 58, powered by a brushless motor 60, supplies cooling oil from an oil reservoir 62 to the first intensifier heat exchanger 56. A speed control 64 for the brushless motor 60 is provided. A brushless motor 60 is preferred to eliminate the risk of sparks. The system controller 500 receives data from the oil temperature sensor, the gaseous hydrogen temperature sensors 42, the gaseous hydrogen pressure sensors 44, and the hydrogen leak sensors 43. The system controller 500 in turn is used to, among other things, effect the speed control 64.

The intensifier is a device, which unlike a simple compressor, can receive gas at varying pressures and provide an output stream at a near constant pressure. However, it may be suitable in some cases to use a compressor in place of an intensifier. The first intensifier 52 increases the pressure of the incoming gaseous hydrogen about four fold. Within the first compressor subsystem 50, hydrogen gas from the feed line 40 enters the first intensifier 52 through an inlet valve 68. The gaseous hydrogen exits the first intensifier through an outlet check valve 70. At this point, the gaseous hydrogen is directed through a cooling unit 300 to manage any temperature increases in the gaseous hydrogen. The gaseous hydrogen passing through the cooling unit 300 may be directed to enter a second compressor subsystem 80 or into a by-pass feed line 90.

If entering the second compressor subsystem 80 the gaseous hydrogen passes through an inlet check valve 82 which directs it to the second intensifier 84. The oil to air heat exchanger 54 for cooling the hydraulic oil which is supplied to a second intensifier heat exchanger 85 to cool the second intensifier 84. An intensifier switch 86, connects to the system controller 400, and controls the start/stop function of the second intensifier 84. The gaseous hydrogen exits the second intensifier 84 through an outlet check valve 87 and is directed down the inlet/outlet line 88 to a line control valve 92 which directs the gaseous hydrogen through a cooling unit 300 and into the inlet/outlet control valves 94 and 94′ for the lightweight composite hydrogen storage tanks 100 and 100.

The dual compressor sub-systems 50 & 80 are not a limitation. If the storage pressure for the hydrogen gas can be achieved with a single compressor sub-system, the second compressor subsystem can be bypassed or eliminated. By closing the inlet check valve 82 to the second intensifier 84, the gaseous hydrogen exiting the first intensifier 52 is directed through the by-pass feed line 90 and to a by-pass inlet/outlet control valve 96 which directs the flow of gaseous hydrogen to the lightweight composite hydrogen storage tanks 100 and 100. Conversely, in those instances where storage pressure exceeding that which can be efficiently achieved with dual intensifiers is desired, additional intensifiers can be added.

The heart of the electrical generation system 200 is the PEMFC stack 210 and the associated balance of plant. The balance of plant in this embodiment includes a humidifier 220, a heat exchanger module 225 such as a finned radiator and an air supply system 230.

A stream of gaseous hydrogen is supplied from the storage tanks 100 & 100 when the line control valve 92 is open. The stream of hydrogen flows through the inlet/outlet line 88 to a first regulator 240. The first regulator 240 decreases the pressure of the hydrogen gas. In this embodiment the regulators are diaphragm based. There are many types of pressure regulators known in the art and the use of a diaphragm based regulator is not a limitation. The first regulator 240 is also connected to a vent 245 to vent the stream of hydrogen gas should the pressure exceed a limit. The reduced pressure stream of hydrogen gas flows from the first regulator 240 through the fuel cell feed line 250 to a second regulator 260 with vent 265. The second regulator 260 further reduces the pressure of the stream of hydrogen. For the PEMFC a 50 psi pressure is a suitable feed pressure. At this point the stream of hydrogen has low humidity (is substantially dry).

The low humidity stream of hydrogen then passes through the humidifier 220, the humidifier introduces moisture in the hydrogen stream through such methods as bubble technologies. A water reservoir 270 is connected to the humidifier 220. The PEMFC requires a humid stream of hydrogen 275 to keep the proton exchange membranes within the PEMFC stack 210 operational, because the polymer membrane in the PEMFC requires moisture to carry ions. In the absence of moisture, high ionic resistance can potentially lead to failure of the membrane. The humid stream of hydrogen 275 flows into the anodes 212 of the PEMFC stack 210.

Oxygen is supplied to the cathodes 214 of the PEMFC stack 210 via the air supply system 230 which comprises an air compressor 232, a compressor motor 234 and an air inlet 236. The compressed atmospheric air is directed via the oxygen feed line 280 to the cathodes 214.

During operation the quantity of hydrogen consumed by the PEMFC stack 210 is proportional to the quantity of oxygen provided. Accordingly, there is generally unused hydrogen passing through the PEMFC stack 210. The unused hydrogen can be re-circulated. A hydrogen re-circulation line 300 from the PEMFC 210 feeds the unused hydrogen (which has already been humidified) into a wet re-circulation pump 310. The wet re-circulation pump 310 helps to achieve the required saturation of the anode inlet stream and back into the humidifier 220.

The system controller 500 can control the flow of hydrogen via the line control valve 92 and/or the air supply system 230 via the electric motor 232. Control of the hydrogen supply or the oxygen supply is used to control the output of the PEMFC stack 210.

The electrical generation system 200 produces a DC output 340. A PEMFC stack between about 20 and about 150 KW is preferred. For this embodiment, a 100 KW PEMFC stack 210, which can produce a current between about 100 and 800 volts, is provided. The DC output 340 passes into the power conditioning system 350 both a DC/DC converter 360 with controller 365 and a power inverter 370 with controller 375. The DC/DC converter 360 can be used to step down the PEMFC stack 210 voltage and power on board systems such as the air compressor motor 232, other low voltage components, and recharge a back-up battery 380. Although a 100 KW PEMFC stack is indicated, the 100 KW size is not a limitation. The size of the stack in KWS and the stack configuration will effect the output in terms of voltage and amperage. The preferred stack for any usage will depend on the voltage and amperage requirements.

The DC output 385 from the DC/DC converter 360 and the AC output 390 from the DC/AC inverter 370 is available for use at an output power panel 395. Referring now to FIGS. 1 and 2, the output power panel 395 in FIG. 3 is located at the electrical panel 17.

An alternative hydrogen supply source to feed hydrogen into the hydrogen storage subsystem 30 is a reformer 400 with controller 410, whereby a hydrogen rich fuel provide from a fuel tank 415 passes through a valve 417 to the reformer 400 to release a stream of hydrogen gas from the fuel. Reformation of hydrogen rich fuels is well known in the art and therefore a detailed description of the construction of a reformer is not provided.

Another alternative hydrogen supply source to feed hydrogen into the hydrogen storage subsystem 30 is an electrolyzer 430 which is comprised of a KOH electrolyzer module 432 and a cooling module 434. One suitable KOH electrolyzer is a IMET electrolyzer manufactured by Vandenborre Hydrogen Systems. The cooling module 434 should be sufficient to reduce the temperature to at or below ambient for maximum volume in the hydrogen storage tanks 100. The cooling module 434 may be a closed loop cooler, receive a water input, or use heat exchangers and or radiators.

A polymer electrolyte membrane (PEM) electrolyzer 440 may be substituted for the IMET electrolyzer. A PEM electrolyzer splits hydrogen from a water source and generates a hydrogen gas stream. Both the electrolyzer and the polymer electrolyte membrane are known in the art and therefore a detailed description of their construction is not necessary.

Both the electrolyzer module 430 and the PEM electrolyzer 440 require electricity to operate. The electricity may be from an electrical grid connection, or other electrical generator. In some instance the electricity to drive the electrolyzer module 430 or the PEM electrolyzer 440 can be obtained from renewable sources such as solar (photovoltaic) or wind-power.

Shown in FIGS. 5 and 6 are alternative component arrangements within a trailer 14 or an enclosure module 24 of the hydrogen storage subsystem 30, electrical generation system 200 and the power conditioning system 350. In FIG. 6 the alternative hydrogen supply sources, reformer 400, electrolyzer 430 and polymer electrolyte membrane (PEM) electrolyzers 440 are also shown.

The transportable fuel cell generator may remain on the trailer as shown in FIG. 5 or be removed (FIGS. 2 and 3) sleds 450 on the base of a removable enclosure 24 are shown in FIG. 6.

Since certain changes may be made in the above apparatus without departing from the scope of the invention herein involved, it is intended that all matter contained in the above description, as shown in the accompanying drawing, shall be interpreted in an illustrative, and not a limiting sense.

We claim:

1. A fuel cell generator comprising:
a portable enclosure;
a fuel cell stack within the enclosure;
a hydrogen storage means within the enclosure;
a hydrogen supply means at least partially within the enclosure, whereby hydrogen is supplied to the fuel cell stack;
an oxygen supply means at least partially within the enclosure, whereby oxygen is supplied to the fuel cell stack;
a power condition means; and,
at least one system controller.

2. The fuel cell generator of claim 1 wherein the hydrogen storage means comprises:
at least one feed line where into hydrogen can flow;
at least one compressor means connected to the at least one feed line;
one or more hydrogen storage tanks connected to the at least one feed line downstream from the at least one compressor means;
at least one control valve connected to the at least one feed line; and,
the at least one system controller controls at least one of the at least one control valve and the at least one compressor means, whereby the flow of hydrogen is affected.

3. The fuel cell generator of claim 2 wherein each compressor means comprises an oil cooled intensifier.

4. The fuel cell generator of claim 2 wherein the oxygen supply means comprises
at least one air inlet line; and,
at least one air compressor connected at one end to the at least one air inlet line and at the other end to the fuel cell stack.

5. The fuel cell generator of claim 1 wherein the power conditioning means comprises at least one inverter with controller whereby the DC of the fuel cell stack is converted to AC.

6. The fuel cell generator of claim 1 wherein the power conditioning means comprises at least one DC converter with controller whereby the voltage of the DC output of the fuel cell stack is stepped down.

7. The fuel cell generator of claim 1 wherein the power conditioning means comprises:
at least one DC converter with controller whereby the voltage of the DC output of the fuel cell stack can be stepped down; and,
at least one inverter with controller whereby DC output of the fuel cell stack can be converted to AC.

8. The fuel cell generator of claim 7 wherein the system controller also controllers at least one of the inverter controller, the DC converter controller, and the air compressor.

9. The fuel cell generator of claim 1 further comprising a trailer onto which the portable enclosure is mounted.

10. The fuel cell generator of claim 1 further comprising a trailer onto which the portable enclosure is removably mounted.

11. The fuel cell generator of claim 10 wherein the portable enclosure further comprises a moving means.

12. The fuel cell generator of claim 11 wherein the moving means is at least one axel; with at least one wheel at each end; affixed to the enclosure.

13. The fuel cell generator of claim 11 wherein the moving means is a sled.

14. A transportable fuel cell generator comprising a trailer;
an enclosure on the trailer;
a fuel cell stack within the enclosure;
a hydrogen storage means within the enclosure;
a hydrogen supply means at least partially within the enclosure, whereby hydrogen is supplied to the fuel cell stack;
an oxygen supply means at least partially within the enclosure, whereby oxygen is supplied to the fuel cell stack;
a power conditioning means; and,
at least one system controller.

15. The transportable fuel cell generator of claim 14 wherein the hydrogen storage means comprises:
at least one feed line where into hydrogen can flow;
at least one compressor means connected to the at least one feed line;
one or more hydrogen storage tanks connected to the at least one feed line downstream from the at least one compressor means;
at least one control valve connected to the at least one feed line; and,
system controller controls at least one of the at least one control valve and the at least one compressor means, whereby the flow of hydrogen is affected.

16. The transportable fuel cell generator of claim 15 wherein the oxygen supply means comprises:m,.n
at least one air inlet line; and,
at least one air compressor connected at one end to the at least one air inlet line and at the other end to the fuel cell stack.

17. The transportable fuel cell generator of claim 14 wherein the power conditioning means comprises at least one inverter with controller whereby the DC of the fuel cell stack is converted to AC.

18. The transportable fuel cell generator of claim 14 wherein the power conditioning means comprises at least one DC converter with controller whereby the voltage of the DC output of the fuel cell stack is stepped down.

19. The transportable fuel cell generator of claim 14 wherein the power conditioning means comprises:
at least one DC converter with controller whereby the voltage of the DC output of the fuel cell stack can be stepped down; and,
at least one inverter with controller whereby DC output of the fuel cell stack can be converted to AC.

20. The transportable fuel cell generator of claim 19 wherein the system controller also controllers at least one of the inverter controller, the DC converter controller, and the air compressor.

21. A method of providing fuel cell generated electrical power the method comprising:
transporting an enclosure, on a trailer, containing a fuel cell stack, balance of plant hydrogen supply means, oxygen supply means, power conditioner and system controller to a location;
generating electricity by providing hydrogen and oxygen to the fuel cell stack; and,
outputting the electricity generated by the fuel cell stack, within the enclosure.

22. The method of claim 21 further comprising disassociating the enclosure from the trailer before outputting the electricity.

23. The method of claim 21 the method further comprising conditioning the electricity generated from the fuel cell stack before outputting the electricity.
